(19) United States
(12) Patent Application Publication
(10) Pub. No.: US 2010/0250071 A1
(43) Pub. Date: Sep. 30, 2010

(54) DUAL FUNCTION TOUCH SWITCH WITH HAPTIC FEEDBACK

(75) Inventors: Silviu Pala, Birmingham, MI (US); Justin McBride, W. Bloomfield, MI (US); Christopher A. Arms, Farmington Hills, MI (US); Bo Sun, Novi, MI (US); Carolina M. Giannotti, Riverview, MI (US); Daniel P. Tran, W. Bloomfield, MI (US); Nhi Van Pham, Dearborn, MI (US); Martin E. Nespolo, Rochester Hills, MI (US)

Correspondence Address: HARNESS, DICKEY & PIERCE, P.L.C., P.O. BOX 828, BLOOMFIELD HILLS, MI, 48303, US

(73) Assignee: DENSO International America, Inc., Southfield, MI (US)

(21) Appl. No.: 12/751,634

(22) Filed: Mar. 31, 2010

Related U.S. Application Data
(63) Continuation-in-part of application No. 12/079,871, filed on Mar. 28, 2008.

(51) Int. Cl. G06F 7/00; H03K 17/94; G08B 6/00; G09G 5/00; G06F 3/041

(52) U.S. Cl. 701/48; 341/20; 340/407.2; 345/156; 345/173

(57) ABSTRACT

A control interface system is disclosed. The system comprises an input device that receives input of a user to control a plurality of systems of the vehicle and a plurality of dual function sensors interposed along a surface of said input device. Each of the dual function sensors includes a first circuit that is sensitive to contact of the user with the surface of said input device and a second circuit sensitive to pressure exerted upon the surface of the input device greater than a predetermined threshold. The dual function sensors generate a first signal when the first circuit senses the contact of the user and generate a second signal when the second circuit senses the pressure exerted upon the surface of the input device. The system further includes a processing unit which receives the first and second signals and controls the plurality of systems within the vehicle based upon the received signals.

### CROSS-REFERENCE TO RELATED APPLICATIONS

This application is a continuation-in-part of U.S. patent application Ser. No. 12/079,871 filed on Mar. 28, 2008. The entire disclosure of the above application is incorporated herein by reference.

### FIELD

The present disclosure relates to human machine interfaces and, more particularly, to an improved control interface for a driver of a vehicle.

### BACKGROUND

The statements in this section merely provide background information related to the present disclosure and may not constitute prior art. Indicating instruments or gauges for viewing by drivers of vehicles generally include an analog portion for displaying and/or controlling vehicle operating conditions, such as the temperature of the interior cabin of a vehicle. In more recent vehicles, indicating instruments generally include a liquid crystal display (LCD) for displaying and/or controlling the vehicle operating conditions. An analog device typically includes a faceplate having indicia adjacent a scale to denote levels of the scale and a pointer for rotating to the indicia and scale numbers, such as mile per hour markings. While such analog and LCD devices have generally proven satisfactory for their intended purposes, they have been associated with their share of limitations.

One such limitation of current vehicles with analog and/or LCD devices relates to their safety. Because such analog and LCD devices are normally located in separate, side-by-side locations on a dash of a vehicle, a driver of the vehicle may have to remove his or her hands a far distance from a steering wheel of the vehicle to reach and adjust vehicle operating conditions. While adjusting the vehicle operating conditions on the analog and LCD devices, the driver may not be ready to make a sudden, emergency turn, for example.

Another limitation of current vehicles employing analog and/or LCD devices is related to their accuracy of use. To avoid accidents, the driver has to preferably adjust vehicle operating conditions on the analog and LCD devices while keeping his or her eyes on the road. Without being able to look at the analog and LCD devices, the driver may incorrectly adjust the vehicle operating conditions.

What is needed then is a device that does not suffer from the above disadvantages. This, in turn, will provide an LCD device that is safe for the driver to control. In addition, the LCD device should lead to accurate use even without having to see the LCD device.

### SUMMARY

In one aspect a control interface system in a vehicle is described. The control interface system comprises an input device that receives input of a user to control a plurality of systems of the vehicle and a plurality of dual function sensors interposed along a surface of said input device. Each of the dual function sensors includes a first circuit that is sensitive to contact of the user with the surface of said input device and a second circuit sensitive to pressure exerted upon the surface of the input device greater than a predetermined threshold. The dual function sensors generate a first signal when the first circuit senses the contact of the user and generate a second signal when the second circuit senses the pressure exerted upon the surface of the input device. The system further includes a processing unit which receives the first and second signals and controls the plurality of systems within the vehicle based upon the received signals.

In another aspect, a user input device for controlling a plurality of adjustable settings of one or more systems in a vehicle is described. The device comprises a plurality of dual function sensors disposed along a surface of said device, each of the dual function sensors having a contact sensitive circuit, a pressure sensitive circuit, and a feedback circuit. The contact sensitive circuit is configured to generate a first signal indicating contact between a user and the dual function sensor and a location thereof. The pressure sensitive circuit is configured to generate a second signal indicating that an amount of pressure exceeding a predetermined threshold is being applied to the dual function sensor. The feedback circuit is configured to generate feedback to the user indicating that at least one of the contact sensitive circuit and the pressure sensitive circuit has been activated. The device further includes a central processing unit configured to receive the first signals and the second signals from the plurality of dual function sensors and to determine a location and type of user input based on the received signals, wherein said user input controls a current adjustable setting of the plurality of adjustable settings.

### DRAWINGS

The drawings described herein are for illustration purposes only and are not intended to limit the scope of the present disclosure in any way.

FIG. 1 is a perspective view of an interior cabin of a vehicle depicting a location of a display information center (DIC) and a haptic tracking remote;

FIG. 2 is a functional block diagram of a control interface system that includes a DIC module of the DIC of FIG. 1 and a remote haptic module (RHM) of the haptic tracking remote of FIG. 1 in accordance with an embodiment of the present invention;

FIG. 3 is a perspective view of an embodiment of the RHM of FIG. 2;

FIG. 4 is a top view of the RHM of FIG. 3;

FIG. 5 is a functional block diagram of an embodiment of switches of the RHM of FIG. 3;

FIG. 6 is a side view of an embodiment of the RHM of FIG. 2;

FIG. 7 is a side view of an embodiment of the RHM of FIG. 2;

FIG. 8 is a functional block diagram of an embodiment of an input module interface and a feedback module of the RHM of FIG. 7;

FIG. 9A is a graph depicting an applied force over a time for a piezo sensor of the input module interface of FIG. 8;

FIG. 9B is a graph depicting a sensor voltage over a time for the piezo sensor of FIG. 8;

FIG. 9C is a graph depicting an actuator voltage over a time for a piezo actuator of the feedback module of FIG. 8;

FIG. 9D is a graph depicting an actuator force over a time for the piezo actuator of FIG. 8;

FIG. 10A is a flowchart depicting exemplary steps performed by a control module of the control interface system of FIG. 2 in accordance with an embodiment of the present invention;

FIG. 10B is a portion of the flowchart of FIG. 10A;

FIG. 11A is a screenshot illustrating an input module of the RHM of FIG. 2 when the mode is a search mode in accordance with an embodiment of the present invention;

FIG. 11B is a screenshot illustrating a display of the DIC module of FIG. 2 when the mode is the search mode in accordance with an embodiment of the present invention;

FIG. 12A is a screenshot illustrating the input module of FIG. 2 when the mode is a select mode;

FIG. 12B is a screenshot illustrating the display of FIG. 2 when the mode is the select mode;

FIG. 13A is a screenshot illustrating the input module of FIG. 2 when the mode is an execute mode; and

FIG. 13B is a screenshot illustrating the display of FIG. 2 when the mode is the execute mode

FIG. 14 is a top view of an exemplary input device;

FIG. 15 is a side-view of an exemplary dual-function sensor;

FIG. 16 is a side-view of an alternative exemplary dual-function sensor;

FIG. 17 is a side-view of an alternative exemplary dual-function sensor;

FIG. 18A is a drawing depicting a top view of an input module;

FIG. 18B is a drawing depicting a display corresponding to an input module;

FIG. 18C is a drawing depicting a sensor of an input module in communication with a central processing unit;

FIG. 19A is a drawing depicting a top view of an input mo

FIG. 19B is a drawing depicting a display corresponding to an input module; and

FIG. 20 is a flow chart of an exemplary method that may be executed by the central processing unit.

### DETAILED DESCRIPTION

The following description is merely exemplary in nature and is not intended to limit the present disclosure, application, or uses. It should be understood that throughout the drawings, corresponding reference numerals indicate like or corresponding parts and features. As used herein, the term module or unit refers to an Application Specific Integrated Circuit (ASIC), an electronic circuit, a processor (shared, dedicated, or group) and memory that execute one or more software or firmware programs, a combinational logic circuit, and/or other suitable components that provide the described functionality.

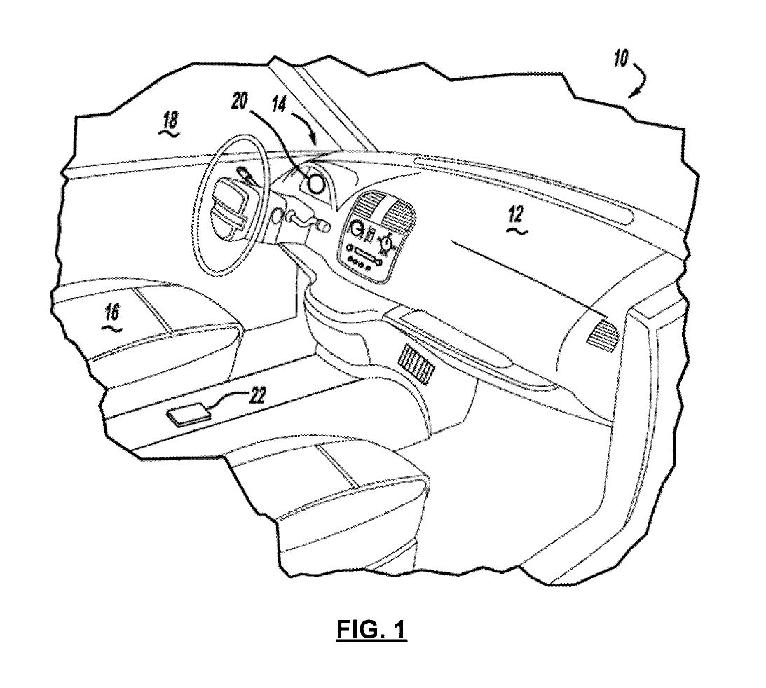

Turning now to FIG.'s 1-13, the teachings of the present invention will be explained. With initial reference to FIG. 1, depicted is a vehicle 10 having a dash 12 and an instrument panel 14, both of which may be situated in front of a driver's seat 16 in an interior cabin 18 of the vehicle 10. As part of the instrument panel 14, a display information center (DIC) 20 is depicted and may be exemplified by an indicating instrument or gauge, such as, but not limited to, a thermometer for the interior cabin 18. The DIC 20 is connected to a haptic tracking remote 22 that controls the DIC 20 as described herein. It is understood that the locations of the devices depicted are exemplary and other devices and device locations are within the scope of the disclosure. For instance, the haptic tracking remote may be a touchpad on the rear of the steering wheel or the DIC may be projected onto the windshield as a heads-up display.

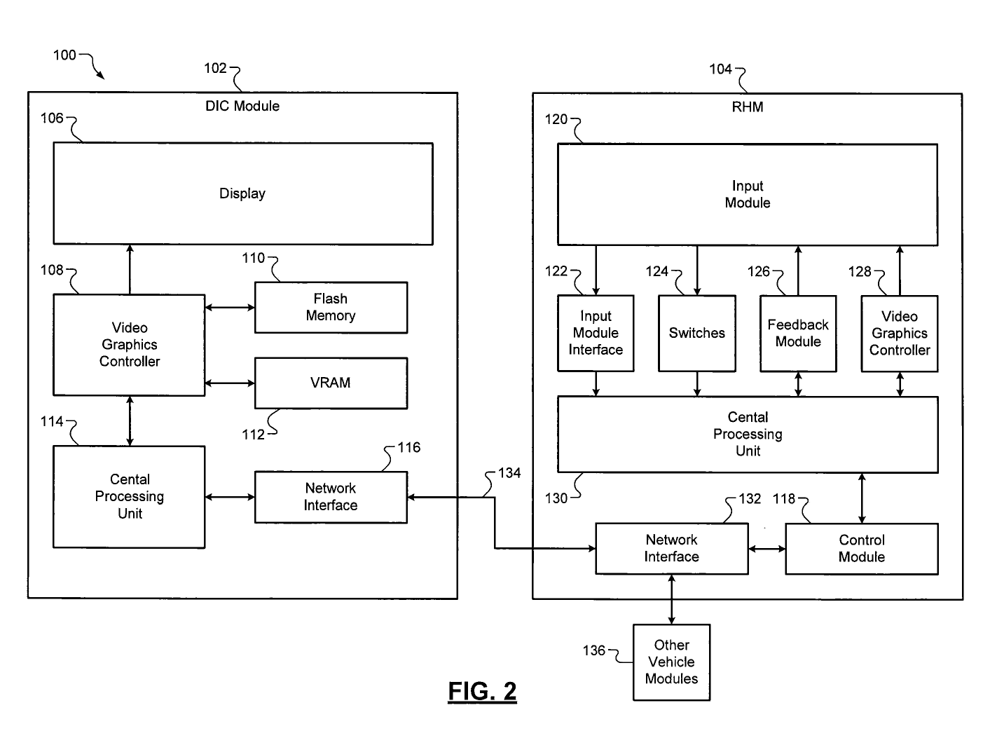

Turning now to FIG. 2, an exemplary control interface system 100 is shown. The control interface system 100 includes a DIC module 102 of the DIC 20 and a remote haptic module (RHM) 104 of the haptic tracking remote 22. The DIC module 102 includes a display 106, a video graphics controller 108, a flash memory 110, a video random access memory (VRAM) 112, a central processing unit 114, and a network interface 116. The RHM 104 includes an input module 120, an input module interface 122, switches 124, a feedback module 126, a video graphics controller 128, a central processing unit 130, a control module 118, and a network interface 132. In other embodiments of the present invention, the control module 118 may be located in only the DIC module 102, or in both the DIC module 102 and the RHM 104.

The input module 120 may be, but is not limited to, a touchpad or a touchscreen. For example only, the touchscreen may be a thin film transistor liquid crystal display. The input module 120 includes at least one control icon centered at coordinates (i.e., control icon coordinates) on the surface of the input module 120. A driver of the vehicle 10 touches the control icon to control the DIC module 102. The input module 120 further includes at least one value of the instrument panel 14 (i.e., a control value).

The control icon's data and image may be predetermined and may reside in the flash memory 110 and be downloaded to the RHM 104, or vice versa (not shown). For example only, the control icon's image may be in one of different geometric shapes. In addition, the control icon's image (i.e., shape and color) may be customized by the driver via a graphical user interface.

For example only, several control icon images may be predetermined and selected by the driver. Alternatively, the control icon images may be created by the driver on a web site and downloaded to the RHM 104 or the DIC module 102. The driver's image settings may be stored in local memory (not shown).

If the driver wants to execute a command of the control icon, the driver may do any of the following three options (individual or combined). For example only, the command may be to set, increase, or decrease a value of the instrument panel 14, such as a temperature of the interior cabin 18. One, the driver may touch the control icon with an applied force, remove his or her touch, and touch the control icon again within a predetermined time (i.e., perform an “OFF-ON sequence”). Two, the driver may touch the control icon with an applied force that is greater than a predetermined value (i.e., a hard force). Three, the driver may activate a voice recognition module (not shown) and voice the command.

The input module interface 122 detects the applied force, a location of the applied force on the surface of the input module 120 (i.e., an applied force location), and voice commands of the driver. To detect the applied force, the input module interface 122 may include a piezo device, a standard force/displacement gauge, a hall-effect switch, and/or a shock detection accelerometer transducer. To detect the voice commands, the input module interface 122 may include the voice recognition module. The input module interface 122 generates a sensor signal based on the detected applied force, the detected applied force location, and/or the detected voice commands. The central processing unit 130 receives the sensor signal and processes the sensor signal.

The switches 124 may be used to detect the applied force that is greater than the hard force. The switches 124 include mechanical switches. When the applied force is greater than the hard force, the input module 120 moves completely to toggle the mechanical switches. When toggled, the mechanical switches connect or disconnect a circuit between a voltage source (not shown) and the central processing unit 130. The voltage source may be located within the input module 120 and generates a sensor signal that indicates that the applied force is greater than the hard force. When the circuit is connected, the central processing unit 130 receives the sensor signal that indicates that the applied force is greater than the hard force.

The video graphics controller 128 may generate and output images of the control icon, the control value, other data of the vehicle 10, and/or a graphical user interface to the input module 120. The images may be predetermined and may reside in the flash memory 110 and be downloaded to the RHM 104, or vice versa (not shown). In addition, the images may be customized by the driver via the graphical user interface. The driver's image settings may be stored in local memory.

For example only, the display 106 may be a thin film transistor liquid crystal display. The display 106 includes at least one display icon centered at coordinates (i.e., display icon coordinates) on the surface of the display 106 and at least one value of the instrument panel 14 (i.e., a display value). The display icon's data and image may be predetermined and may reside in the flash memory 110 and be downloaded to the RHM 104, or vice versa (not shown). For example only, the display icon's image may be in one of different geometric shapes.

In addition, the display icon's image may be customized by the driver via a graphical user interface. For example only, several display icon images may be predetermined and selected by the driver. Alternatively, the display icon images may be created on a web site and downloaded to the DIC module 102 or the RHM 104. The driver's image settings may be stored in local memory.

The surface of the input module 120 is mapped onto the surface of the display 106. In other words, the surface of the display 106 is a virtual image of the surface of the input module 120. The surface of the input module 120 may have to be scaled in order to be mapped onto the surface of the display 106. An amount of horizontal pixels of the surface of the display 106 H may be determined according to the following equation:

H=h*s, (1)

where h is an amount of horizontal pixels of the surface of the input module 120 and s is a horizontal scale factor. An amount of vertical pixels of the surface of the display 106 V may be determined according to the following equation:

V=v*t, (2)

where v is an amount of vertical pixels of the surface of the input module 120 and t is a vertical scale factor.

The control icon is mapped into the display icon. The control icon coordinates may have to be scaled in order to be mapped into the display icon. The video graphics controller 108 and the VRAM 112 generate and output images of the display icon, the display value, other data of the vehicle 10, and/or the graphical user interface to the display 106.

The images may be predetermined and may reside in the flash memory 110 and be downloaded to the RHM 104, or vice versa (not shown). In addition, the images may be customized by the driver via the graphical user interface. The driver's image settings may be stored in local memory.

The control module 118 receives the processed sensor signal from the central processing unit 130 and determines the applied force based on the processed sensor signal. The control module 118 determines whether the applied force is greater than a minimum force. The minimum force is less than the hard force and a predetermined value. If the applied force is greater than the minimum force, the control module 118 sets a mode of the control interface system 100 to a search mode.

The control module 118 sets a display signal to an initial signal that commands the DIC module 102 and the RHM 104 to display the images of the display and the control icons, the display and the control values, and the graphical user interface. The network interface 132 receives the display signal and transfers the display signal to the network interface 116 via a network bus 134. For example only, the network interfaces 116 and 132 and the network bus 134 may be parts of a Controller Area Network, a Local Interconnect Network, and/or a wireless network.

The central processing unit 114 receives and processes the display signal from the network interface 116. The video graphics controller 108 and the VRAM 112 receive the processed display signal and generate and output the images of the display icons and the display values to the display 106. The central processing unit 130 receives and processes the display signal from the control module 118. The video graphics controller 128 receives the processed display signal and generates and outputs the images of the control icons and the control values to the input module 120.

The control module 118 determines coordinates of the driver's touch on the surface of the input module 120 (i.e., touch coordinates) based on the processed sensor signal. The control module 118 determines an area of the driver's touch centered at the touch coordinates (i.e., a touch area). The control module 118 determines an area of the driver's touch on the surface of the display 106 (i.e., a virtual touch area) centered at coordinates on the surface of the display 106 (i.e., virtual touch coordinates). The control module 118 determines the virtual touch area based on mapping the touch area into the virtual touch area. For example only, the image of the virtual touch area may be of, but is not limited to, a pointer or a finger on the display 106.

The control module 118 determines the display signal based on the mode and the virtual touch area. When the mode is the search mode, the display signal commands the DIC module 102 to display the image of the virtual touch area along with the images of the display icons, the display values, and the graphical user interface. In other words, the driver's touch on the surface of the input module 120 is tracked, or indicated, on the display 106.

The control module 118 may determine whether the touch coordinates are above the control icon. Alternatively, in another embodiment of the present invention, the control module 118 may determine whether the virtual touch coordinates are above the display icon. If the touch coordinates are above the control icon, or if the virtual touch coordinates are above the display icon, the control module 118 sets the mode to a selection mode.

The control module 118 determines a feedback signal based on the mode and the touch coordinates to provide feedback to the driver to indicate that the control icon has been touched with at least the minimum force. For example only, the intensity of the feedback may change depending on the mode and the control icon the driver touches. The central processing unit 130 receives and processes the feedback signal. The feedback module 126 receives the processed feedback signal.

The feedback module 126 may include a haptic actuator module or a piezo device that provides haptic feedback, such as a haptic vibration, to the driver when the feedback module 126 receives the processed feedback signal. The feedback module 126 may include an audio module (not shown) that provides audio feedback, such as audio of the command of the control icon, to the driver when the feedback module 126 receives the processed feedback signal. The feedback module 126 may provide both haptic and audio feedback at the same time. In addition, the driver may select whether he or she wants haptic feedback, audio feedback, both haptic and audio feedback, or no feedback. The driver's feedback settings may be stored in local memory and/or downloaded to the DIC module 102.

The control module 118 determines the display signal based on the mode, the touch coordinates, and the virtual touch area to change the virtual image to indicate to the driver that the control icon has been touched with at least the minimum force. For example only, the images of the selected display icon and/or the virtual touch area may change in color and/or animation depending on the mode and the control icon the driver touches. When the mode is the select mode, the display signal commands the DIC module 102 to display the changed images of the selected display icon and/or the virtual touch area along with images of any other display icons, the display values, and the graphical user interface.

The control module 118 determines whether the driver executes the command of the control icon based on the processed sensor signal. If the driver executes the command, the control module 118 sets the mode to an execute mode. The control module 118 starts a timing module (not shown). The timing module may be located within the control module 118 or at other locations, such as within the RHM 104, for example.

The timing module includes a timer that begins to increment when the timing module is started. The timing module determines a timer value based on the timer. The control module 118 determines a command signal based on the touch coordinates to execute the command of the control icon.

The amount of times the command is executed is determined based on the timer value. Other vehicle modules 136, such as for example a temperature control module (not shown), receive the command signal from the control module 118 via the network interface 132. The other vehicle modules 136 act accordingly to execute the command of the control icon.

The control module 118 determines the feedback signal based on the mode and the command signal to change the feedback to the driver to indicate that the command of the control icon has been executed. The control module 118 determines the display signal based on the mode, the virtual touch area, and the command signal. The control module 118 changes the images of the executed display icon, the virtual touch area, and/or the corresponding display and the control values to indicate to the driver that the command has been executed.

The display and the control values change depending on the control icon the driver touches. When the mode is the execute mode, the display signal commands the DIC module 102 to display the changed images of the executed display icon, the virtual touch area, and the corresponding display value along with images of any other display icons and display values. In addition, the display signal commands the RHM 104 to display the image of the changed control value along with images of the control icons and any other control values.

The control module 118 determines whether the driver continues to execute the command of the control icon based on the updated processed sensor signal. If the driver continues to execute the command, the control module 118 receives the timer value from the timing module. The control module 118 determines a predetermined maximum period for the command to execute (i.e., a maximum command period). The control module 118 determines whether the timer value is less than the maximum command period.

If the timer value is less than the maximum command period, the control module 118 continues to determine the command signal, the feedback signal, and the display signal. If the timer value is greater than or equal to the maximum command period, the control module 118 resets the timing module and sets the display to a final signal. The final signal commands the DIC module 102 to display the display icons and the display values and commands the RHM 104 to display the control icons and the control values.

The control module 118 receives the timer value. The control module 118 determines whether the timer value is greater than a predetermined period for the DIC module 102 to display the display icons and for the RHM 104 to display the control icons (i.e., a maximum display period). If the timer value is less than the maximum display period, the control module 118 continues to set the display signal to the final signal. If the timer is greater than the maximum display period, the control module 118 sets the display signal to a standby signal. The standby signal may command the DIC module 102 to display only the display values and/or command the RHM 104 to display only the control values.

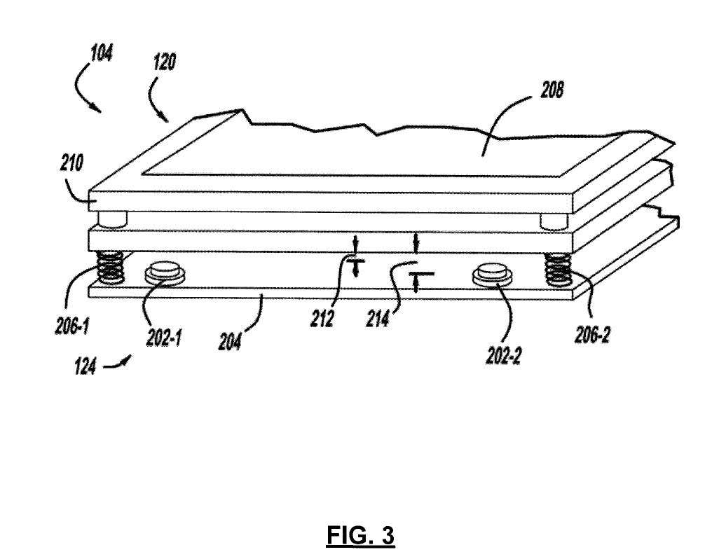

Turning now to FIG. 3, an embodiment of the RHM 104 and associated structure is shown. The switches 124 include mechanical switches 202-1, 202-2 (referred to collectively as mechanical switches 202). The mechanical switches 202 may be pushbuttons.

The RHM 104 includes a hard frame 204 that may be a printed circuit board. The mechanical switches 202 are placed on the hard frame 204. The RHM 104 includes springs 206-1, 206-2 (referred to collectively as springs 206) that are placed between the hard frame 204 and the input module 120. When uncompressed, the springs 206 prevent the input module 120 from touching the mechanical switches 202. The input module 120 includes a touchscreen 208 that is placed within a support structure 210. The support structure 210 may be used to provide the haptic feedback to the driver.

When the driver touches the input module 120 with an applied force that is less than or equal to the hard force, the input module 120 moves a displacement 212 toward the mechanical switches 202. When moved the displacement 212, the input module compresses the springs 206. When the driver touches the input module 120 with an applied force that is greater than the hard force, the input module 120 moves a displacement 214 that is greater than the displacement 212 toward the mechanical switches 202. When moved the displacement 214, the input module 120 compresses further the springs 206 and toggles the mechanical switches 202 to indicate that the applied force is greater than the hard force.

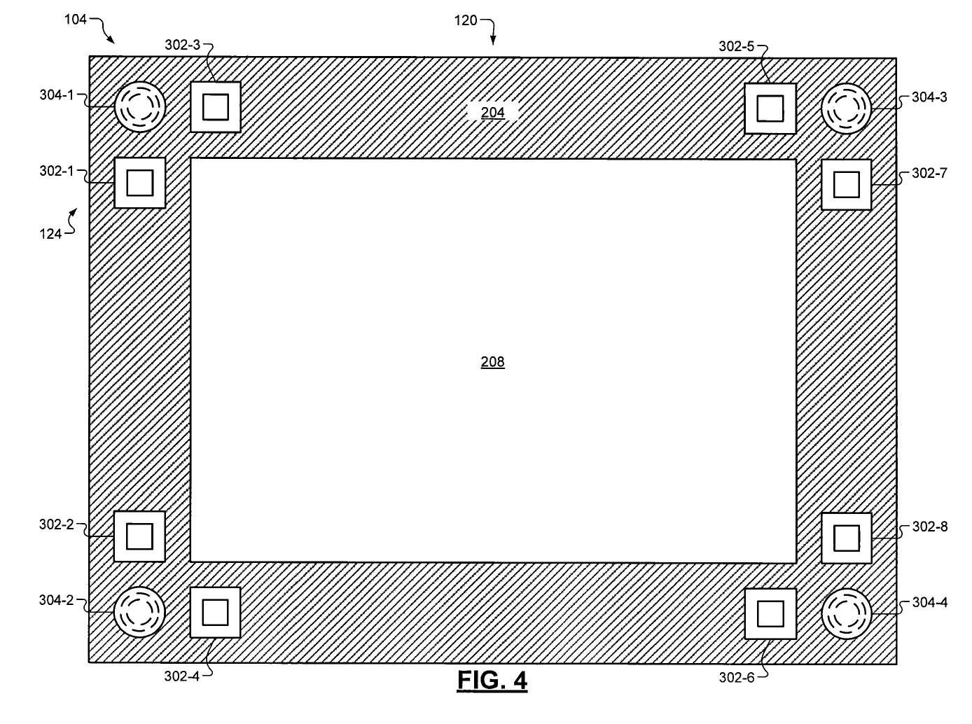

Continuing with FIG. 4, a top view of the RHM 104 and the associate structure is shown. The switches 124 include mechanical switches 302-1, 302-2, 302-3, 302-4, 302-5, 302-6, 302-7, 302-8 (referred to collectively as mechanical switches 302). The mechanical switches 302 may be pushbuttons.

The mechanical switches 302 are placed on the hard frame 204. The RHM 104 includes springs 304-1, 304-2, 304-3, 304-4 (referred to collectively as springs 304). The springs 304 are placed between the hard frame 204 and the input module 120. When uncompressed, the springs 304 prevent the input module 120 from touching the mechanical switches 302. The input module 120 includes the touchscreen 208.

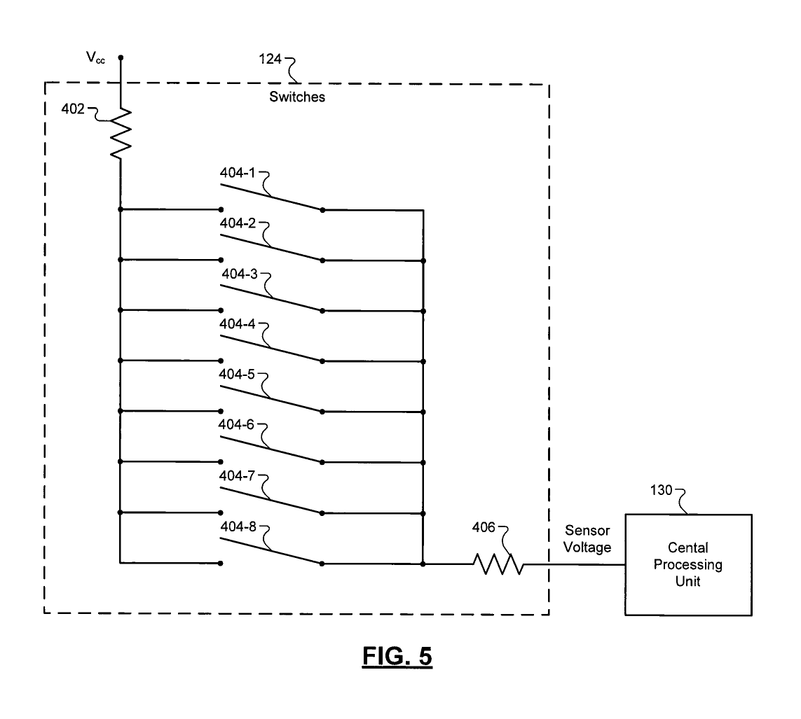

Continuing with FIG. 5, an exemplary functional block diagram of the switches 124 is shown. The switches 124 include a resistor 402 that receives and drops a positive supply voltage (V_{cc}). The positive supply voltage may be from, but is not limited to being from, the input module 120.

The switches 124 further include electrical switches 404-1, 404-2, 404-3, 404-4, 404-5, 404-6, 404-7, 404-8 (referred to collectively as electrical switches 404) and a resistor 406. When toggled, the electrical switches 404 connect or disconnect the circuit between the resistor 402 and the resistors 406. The electrical switches 404 are in an “or” configuration, so any one of the electrical switches 404 may be toggled to connect a circuit between the resistor 402 and the resistor 406. If the circuit is connected, the resistor 406 receives and drops further the positive supply voltage. The central processing unit 130 of the RHM 104 receives the dropped positive supply voltage as the sensor signal that indicates that the applied force is greater than the hard force.

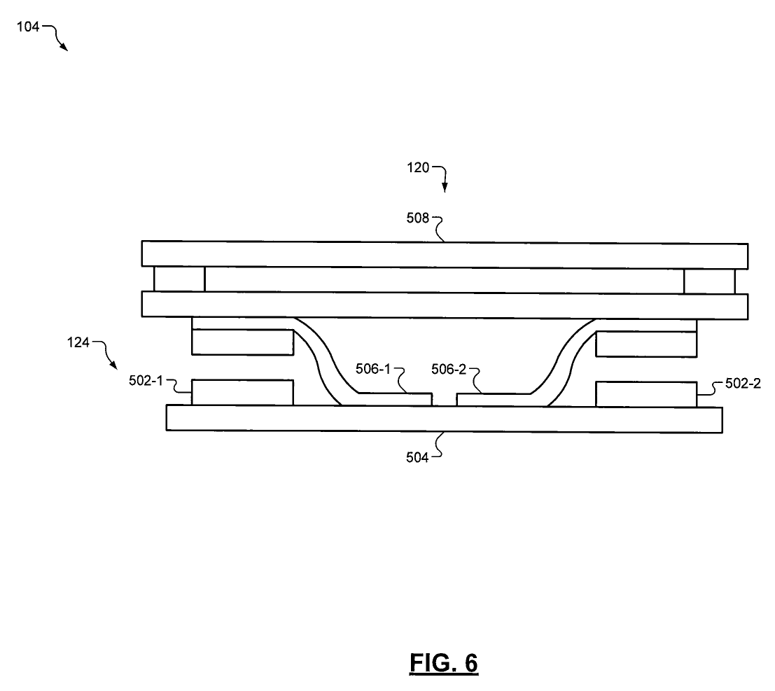

Turning now to FIG. 6, another embodiment of the RHM 104 and associated structure is shown. The switches 124 include contacts 502-1, 502-2 (referred to collectively as contacts 502). The RHM 104 includes a hard frame 504 that may be a printed circuit board. The contacts 502 are placed on the hard frame 504.

The switches 124 further include spring blades 506-1, 506-2 (referred to collectively as spring blades 506) that are welded or soldered onto the hard frame 504. The spring blades 506 are placed between the hard frame 504 and the input module 120. The spring blades 506 may also be welded or soldered onto the bottom surface of the input module 120. When uncompressed, the spring blades 506 prevent the input module 120 from touching the contacts 502.

The input module 120 includes a support structure 508 that may be used to provide the haptic feedback to the driver. When the applied force is greater than the hard force, the input module 120 moves toward the contacts 502 and compresses the spring blades 506. The input module 120 causes the spring blades 506 to touch the contacts 502. When touched, the contacts 502 connect a circuit between the input module 120 and the central processing unit 130 of the RHM 104. When connected, the input module 120 outputs the sensor signal that indicates that the applied force is greater than the hard force to the central processing unit 130.

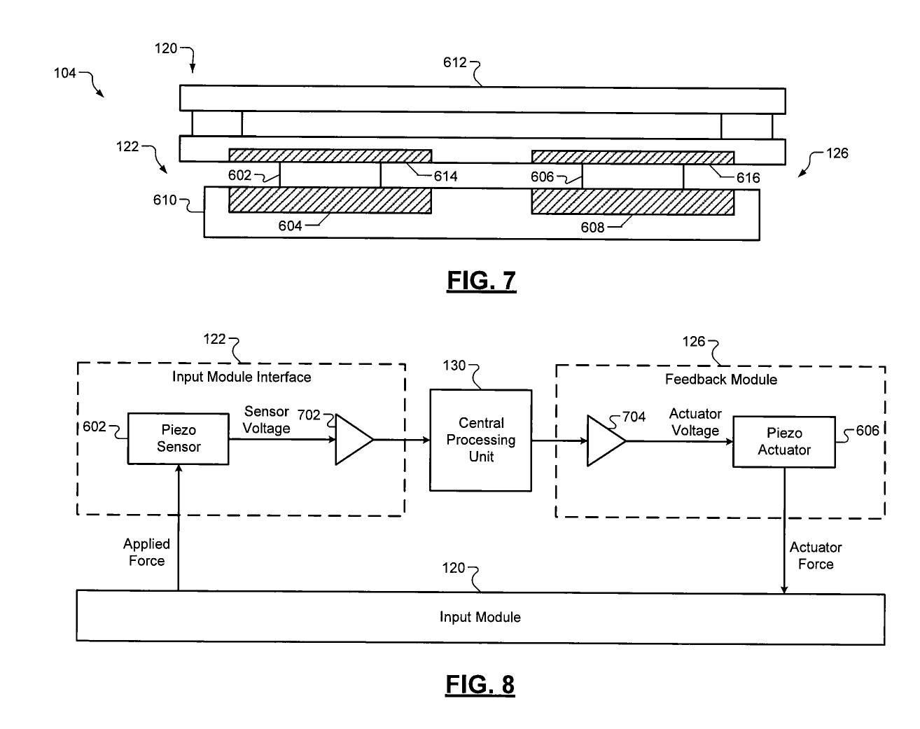

Turning now to FIG. 7, another embodiment of the RHM 104 and associated structure is shown. The input module interface 122 includes a piezo device (i.e., a piezo sensor 602) and copper traces 604. The feedback module 126 includes a piezo device (i.e., a piezo actuator 606) and copper traces 608. Alternatively, in another embodiment of the present invention, the RHM 104 may include a piezo device (i.e., a piezo transducer) that acts as both the piezo sensor 602 and the piezo actuator 606.

The copper traces 604, 608 are placed on the surface of a hard frame 610. The piezo sensor 602 is placed on top of the copper traces 604, while the piezo actuator 606 is placed on top of the copper traces 608. The input module 120 is placed on top of the piezo sensor 602 and the piezo actuator 606. The input module 120 includes a supporting structure 612 that may be used by the feedback module 126 to provide the haptic feedback to the driver. The supporting structure 612 includes indium tin oxide (ITO) traces 614 and ITO traces 616 that electrically and mechanically connect the piezo sensor 602 and the piezo actuator 606, respectively, to the supporting structure 612.

When the driver touches the input module 120 with the applied force, the piezo sensor 602 receives the applied force via the ITO traces 614 and the copper traces 604. The piezo sensor 602 generates a sensor voltage signal based on the applied force. The ITO traces 614 and the copper traces 604 receive the sensor voltage signal for use by the control interface system 100. For example only, the input module interface 122 may determine the sensor signal based on the sensor voltage signal.

To provide the haptic feedback to the driver via the piezo actuator 606, the control interface system 100 determines an actuator voltage signal. For example only, the feedback module 126 may determine the actuator voltage signal based on the feedback signal from the control module 118. The piezo actuator 606 receives the actuator voltage signal via the ITO traces 616 and the copper traces 608. The piezo actuator 606 produces an actuator force based on the actuator voltage signal and outputs the actuator force through the ITO traces 616 and the copper traces 608. The actuator force via the supporting structure 612 provides the haptic feedback to the driver.

Continuing with FIG. 8, an exemplary functional block diagram of the input module interface 122 and the feedback module 126 of the RHM 104 is shown. The input module interface 122 includes a piezo sensor 602 and an amplifier 702. The feedback module 126 includes an amplifier 704 and a piezo actuator 606. Alternatively, in another embodiment of the present invention, the RHM 104 may include a piezo transducer that acts as both the piezo sensor 602 and the piezo actuator 606.

The piezo sensor 602 receives the applied force from the input module 120 and determines the sensor voltage signal based on the applied force. The amplifier 702 receives the sensor voltage signal and amplifies the sensor voltage signal. The central processing unit 130 receives the amplified sensor voltage signal for use by the control interface system 100.

The central processing unit 130 generates the actuator voltage signal. The amplifier 704 receives the actuator voltage signal and amplifies the actuator voltage signal. The piezo actuator 606 receives the amplified actuator voltage signal and produces the actuator force based on the actuator voltage signal. The input module 120 receives the actuator force and is displaced by the actuator force. A change in actuator force ΔFₐ may be determined according to the following equation:

ΔFₐ=k*ΔL, (3)

where k is a predetermined displacement constant and ΔL is a displacement of the input module 120.

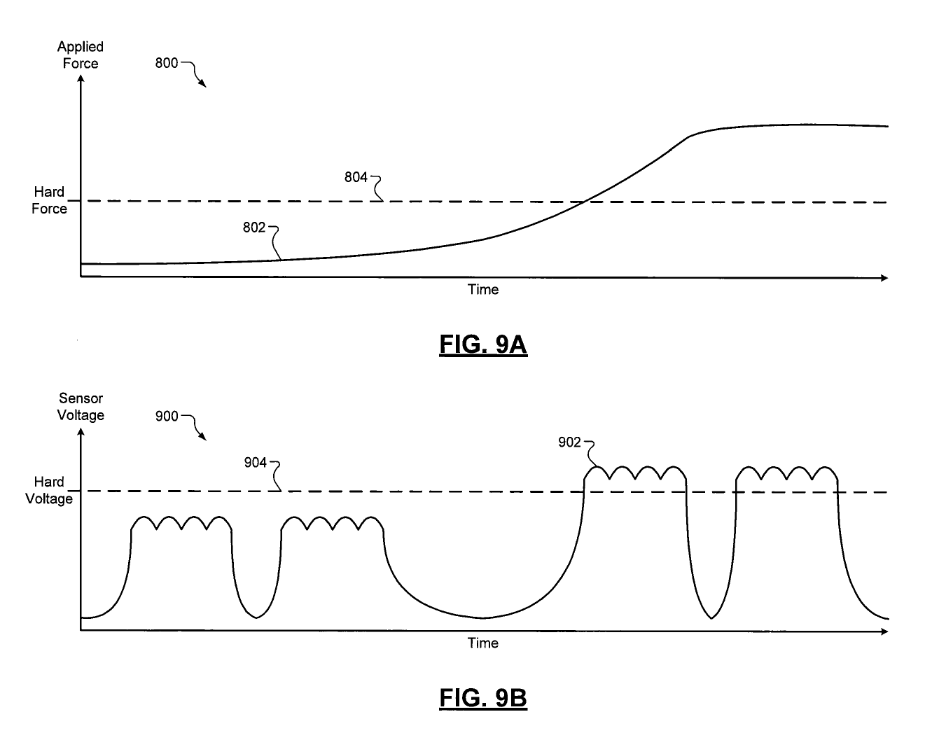

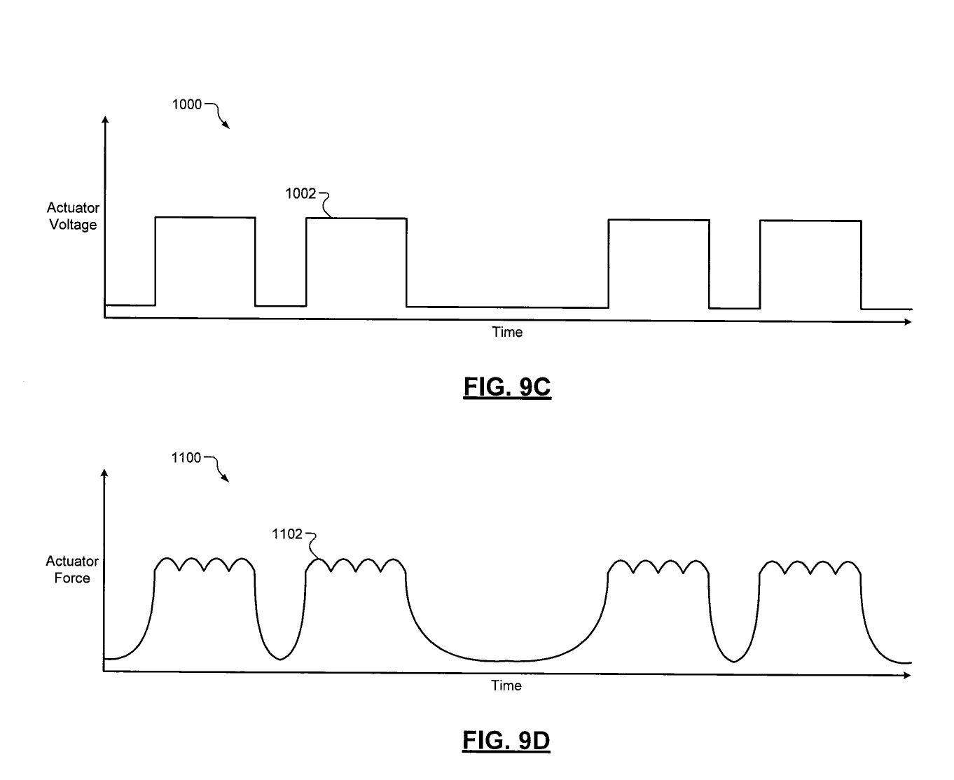

Continuing with FIG. 9A, a graph 800 depicts an applied force 802 versus a time for the piezo sensor 602. The applied force 802 is initially a value below a hard force 804. The applied force 802 increases to a value greater than the hard force 804.

Continuing with FIG. 9B, a graph 900 depicts a sensor voltage 902 versus a time for the piezo sensor 602. The graph 900 is correlated to the graph 800. The sensor voltage 902 is initially a value below a voltage value that is correlated to the hard force 804 (a hard voltage 904). When the applied force 802 increases to a value greater than the hard force 804, the sensor voltage 902 increases to a value greater than the hard voltage 904. The sensor voltage 902 may be sampled and/or filtered to reduce the noise of the sensor voltage 902 and convert the alternating current signal to a direct current signal.

Continuing with FIG. 9C, a graph 1000 depicts an actuator voltage 1002 versus a time for the piezo actuator 606. Each pulse of the actuator voltage 1002 is a command from the control interface system 100 for the piezo actuator 606 to provide the haptic feedback to the driver. The value of the actuator voltage 1002 when the applied force is less than or equal to the hard force may be different than the value when the applied force is greater than the hard force (not shown).

Continuing with FIG. 9D, a graph 1100 depicts an actuator force 1102 versus a time for the piezo actuator 606. The graph 1100 is correlated to the graph 1000. When the actuator voltage 1002 pulses (i.e., increases), the actuator force 1102 pulses. The value of the actuator force 1102 when the applied force is less than or equal to the hard force may be different than the value when the applied force is greater than the hard force (not shown).

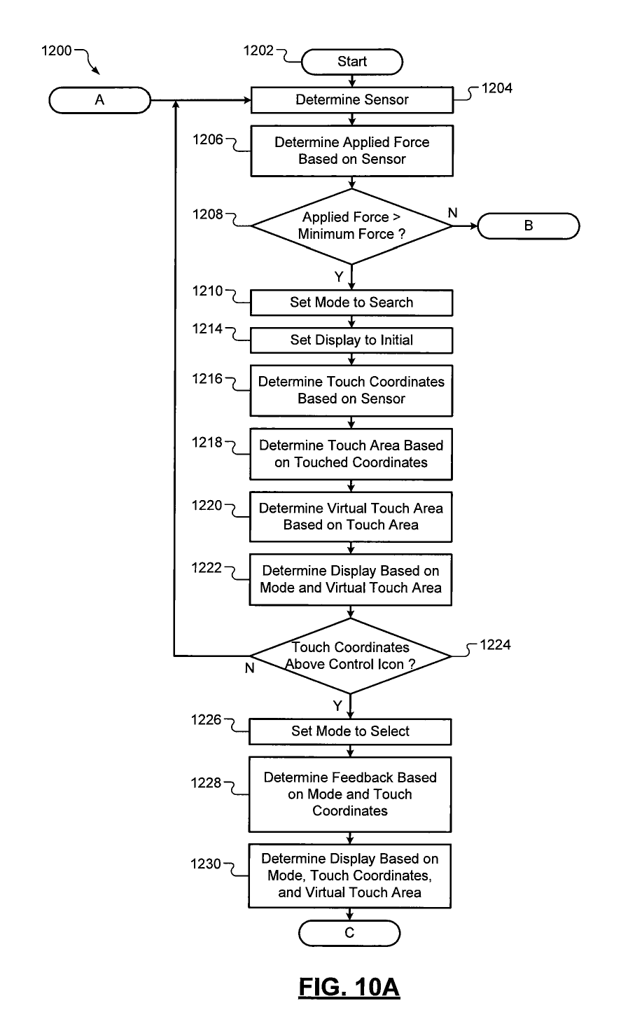

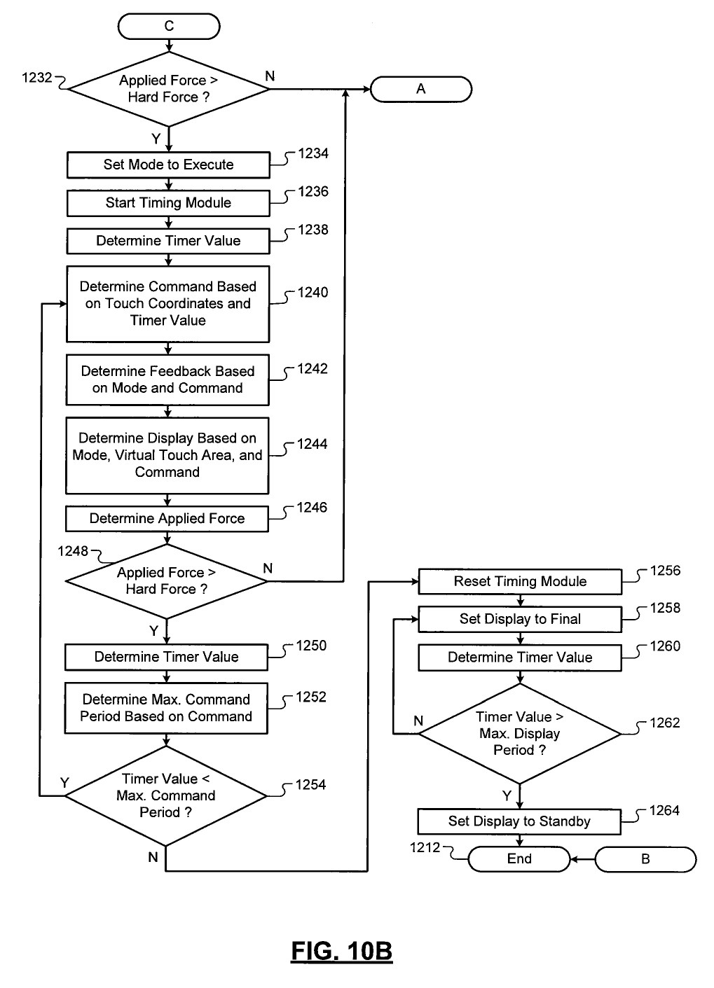

Referring now to FIG. 10A and FIG. 10B, a flowchart 1200 depicts exemplary steps performed by the control module 118 of the control interface system 100. Control begins in step 1202. In step 1204, the sensor signal (i.e., Sensor) is determined.

In step 1206, the applied force is determined based on the sensor signal. In step 1208, control determines whether the applied force is greater than the minimum force. If true, control continues in step 1210. If false, control continues in step 1212.

In step 1210, the mode is set to the search mode (i.e., Search). In step 1214, the display signal (i.e., Display) is set to the initial signal (i.e., Initial). In step 1216, the touch coordinates are determined based on the sensor signal. In step 1218, the touch area is determined based on the touch coordinates.

In step 1220, the virtual touch area is determined based on the touch area. In step 1222, the display signal is determined based on the mode and the virtual touch area. In step 1224, control determines whether the touch coordinates are on the control icon. If true, control continues in step 1226. If false, control continues in step 1204.

In step 1226, the mode is set to the select mode (i.e., Select). In step 1228, the feedback signal (i.e., Feedback) is determined based on the mode and the touch coordinates. In step 1230, the display signal is determined based on the mode, the touch coordinates, and the virtual touch area.

In step 1232, control determines whether the applied force is greater than the hard force. If true, control continues in step 1234. If false, control continues in step 1204. In step 1234, the mode is set to the execute mode (i.e., Execute).

In step 1236, the timing module is started. In step 1238, the timer value is determined. In step 1240, the command signal is determined based on the touch coordinates and the timer value. In step 1242, the feedback signal is determined based on the mode and the command signal.

In step 1244, the display signal is determined based on the mode, the virtual touch area, and the command signal. In step 1246, the applied force is determined. In step 1248, control determines whether the applied force is greater than the hard force. If true, control continues in step 1250. If false, control continues in step 1204.

In step 1250, the timer value is determined. In step 1252, the maximum command period (i.e., Max Command Period) is determined based on the command signal. In step 1254, control determines whether the timer value is less than the maximum command period. If true, control continues in step 1240. If false, control continues in step 1256.

In step 1256, the timing module is reset. In step 1258, the display signal is set to the final signal (i.e., Final). In step 1260, the timer value is determined. In step 1262, control determines whether the timer value is greater than the maximum display period. If true, control continues in step 1264. If false, control continues in step 1258. In step 1264, the display signal is set to the standby signal (i.e., Standby). Control ends in step 1212.

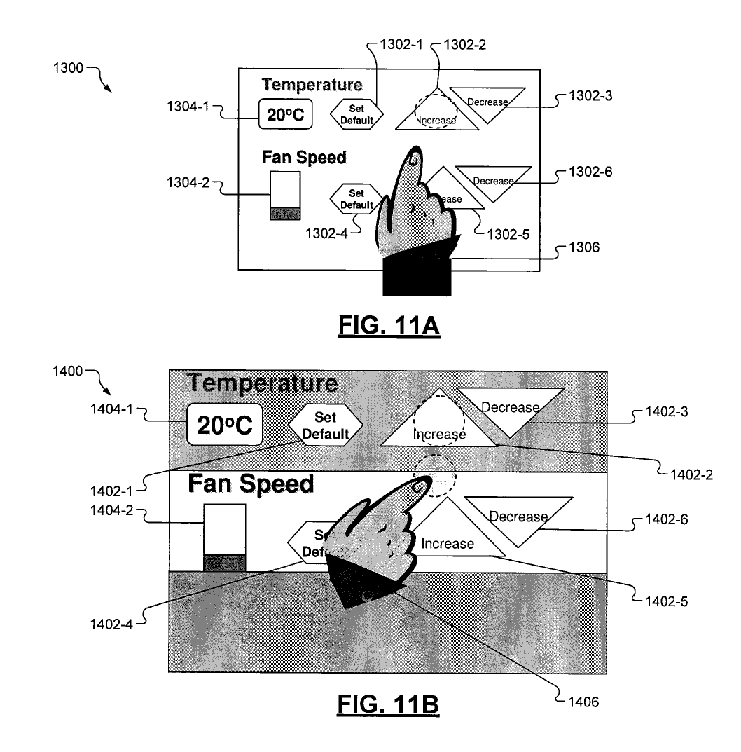

Referring now to FIG. 11A, an exemplary screenshot 1300 depicts the input module 120 of the RHM 104 when the mode is the search mode. The input module 120 includes images of a default temperature control icon 1302-1, an increase temperature control icon 1302-2, a decrease temperature control icon 1302-3. The input module 120 further includes images of a default fan control icon 1302-4, an increase fan control icon 1302-5, and a decrease fan control icon 1302-6 (referred to collectively as control icons 1302).

The input module 120 further includes images of a temperature control value 1304-1 and a fan control value 1304-2 (referred to collectively as control values 1304). When a driver 1306 touches the input module 120 with the applied force that is greater than the minimum force, the mode is set to the search mode. The display signal is set to the initial signal that commands the input module 120 to display the images of the control icons 1302 and the control values 1304.

Continuing with FIG. 11B, an exemplary screenshot 1400 depicts the display 106 of the DIC module 102 when the mode is the search mode. The display 106 includes images of a default temperature display icon 1402-1, an increase temperature display icon 1402-2, a decrease temperature display icon 1402-3. The display 106 further includes images of a default fan display icon 1402-4, an increase fan display icon 1402-5, and a decrease fan display icon 1402-6 (referred to collectively as display icons 1402). The display 106 further includes images of a temperature display value 1404-1 and a fan display value 1404-2 (referred to collectively as display values 1404). The display 106 further includes an image of a virtual touch area 1406.

When the driver 1306 touches the input module 120 with the applied force that is greater than the minimum force, the display signal is set to the initial signal. The initial signal commands the display 106 to display images of the display icons 1402 and the display values 1404. After the virtual touch area 1406 is determined, the display signal is determined based on the mode and the virtual touch area 1406. When the mode is the search mode, the display signal commands the display 106 to display the images of the display icons 1402, the display values 1404, and the virtual touch area 1406.

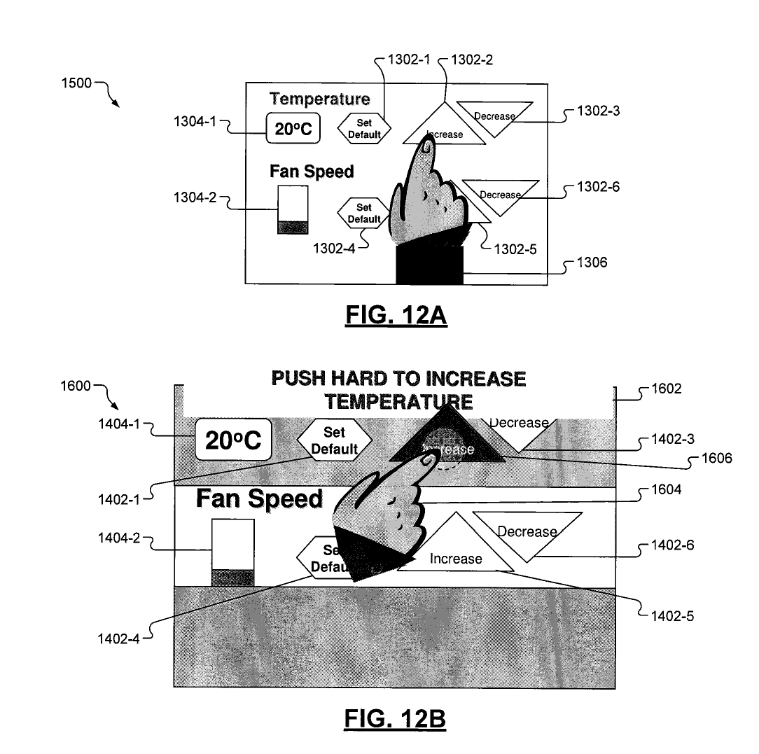

Continuing with FIG. 12A, an exemplary screenshot 1500 depicts the input module 120 of the RHM 104 when the mode is the select mode. When the driver 1306 touches the increase temperature control icon 1302-2 with the applied force that is greater than the minimum force, the mode is set to the select mode. The feedback signal is determined based on the mode and the touch coordinates and commands the feedback module 126 to provide the feedback to the driver 1306.

Continuing with FIG. 12B, an exemplary screenshot 1600 depicts the display 106 of the DIC module 102 when the mode is the select mode. The display 106 includes a help image 1602 and an image of a virtual touch area 1604 that is centered at different virtual touch coordinates than those of the virtual touch area 1406. The display 106 further includes an image of an increase temperature display icon 1606 of a different color than the increase temperature display icon 1402-2.

When the driver 1306 touches the increase temperature control icon 1302-2 with the applied force that is greater than the minimum force, the display signal is determined based on the mode, the touch coordinates, and the virtual touch area 1604. When the mode is the select mode, the display signal commands the display 106 to display the images of the display icons 1402 and the display values 1404. The display signal further commands the display 106 to display the help image 1602 and the images of the virtual touch area 1604 and the increase temperature display icon 1606.

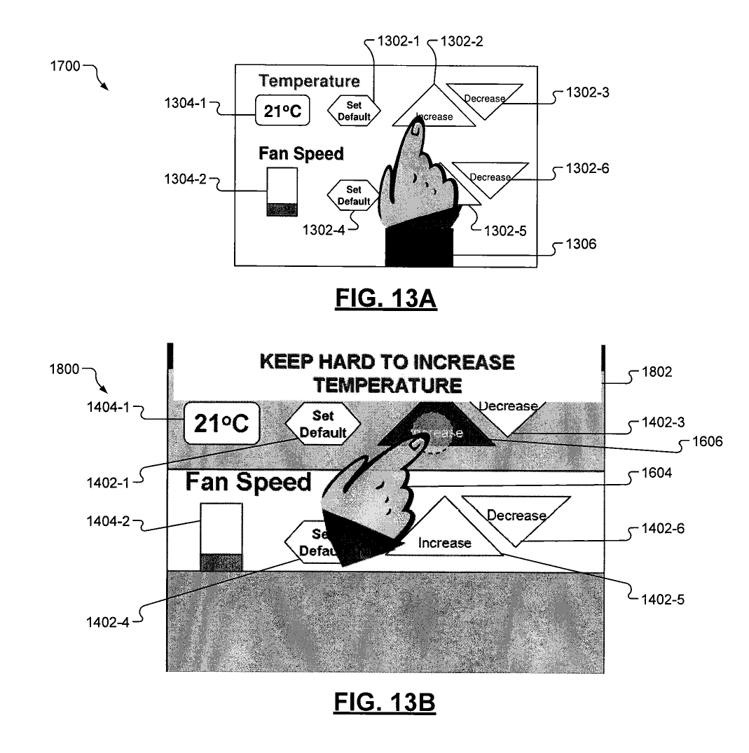

Continuing with FIG. 13A, an exemplary screenshot 1700 depicts the input module 120 of the RHM 104 when the mode is the execute mode. When the driver 1306 executes the command of the increase temperature control icon 1302-2, the mode is set to the execute mode. The feedback signal is determined based on the mode and the command signal and commands the feedback module 126 to provide the feedback to the driver 1306.

Continuing with FIG. 13B, an exemplary screenshot 1800 depicts the display 106 of the DIC module 102 when the mode is the execute mode. The display 106 includes a help image 1802 that is different than the help image 1602. When the driver 1306 executes the command of the increase temperature control icon 1302-2, the display signal is determined based on the mode, the virtual touch area 1604, and the command signal. When the mode is the execute mode, the display signal commands the display 106 to display the images of the display icons 1402, the display values 1404, the virtual touch area 1604, and the increase temperature display icon 1606. The display signal further commands the display 106 to display the help image 1802.

In addition, the display signal commands the display 106 to increase the temperature display value 1404-1 in accordance with the command of the increase temperature control icon 1302-2. The display signal further commands the input module 120 of FIG. 13A to increase the temperature control value 1304-1 in accordance with the command of the increase temperature control icon 1302-2.

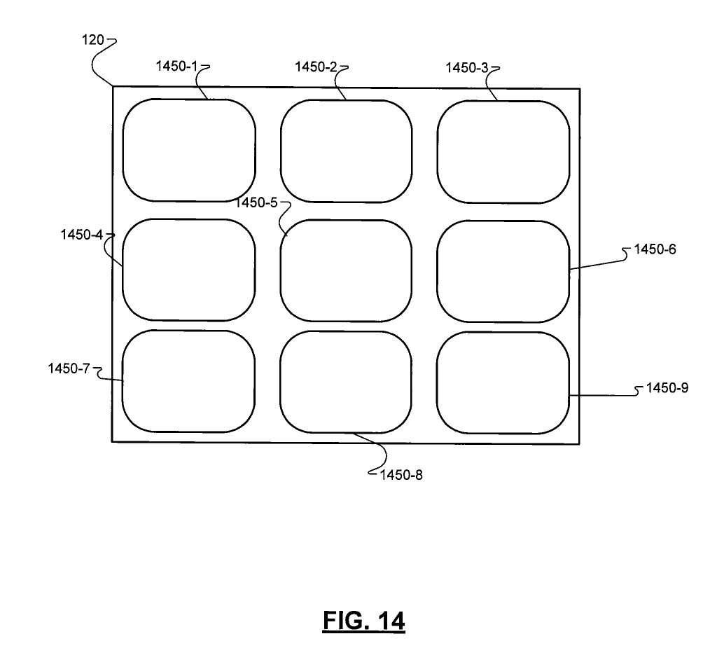

Referring now to FIG. 14, an alternative input device 1450 is shown. The alternative input device 1450 may be a haptic tracking remote, a touch screen or any other device used for touch sensitive input. In this embodiment, the input device 1450 is comprised of a plurality of sensors 1452-1-1452-n configured to generate and communicate a first signal to the central processing unit 130 (FIG. 2) when a user creates contact with the sensor 1452-i and a second signal when the user applies a force greater than a predetermined threshold to the 1452-i. The sensors 1452-1-1452-n are further configured to generate a haptic feedback to the user when a particular sensor 1452-i is activated.

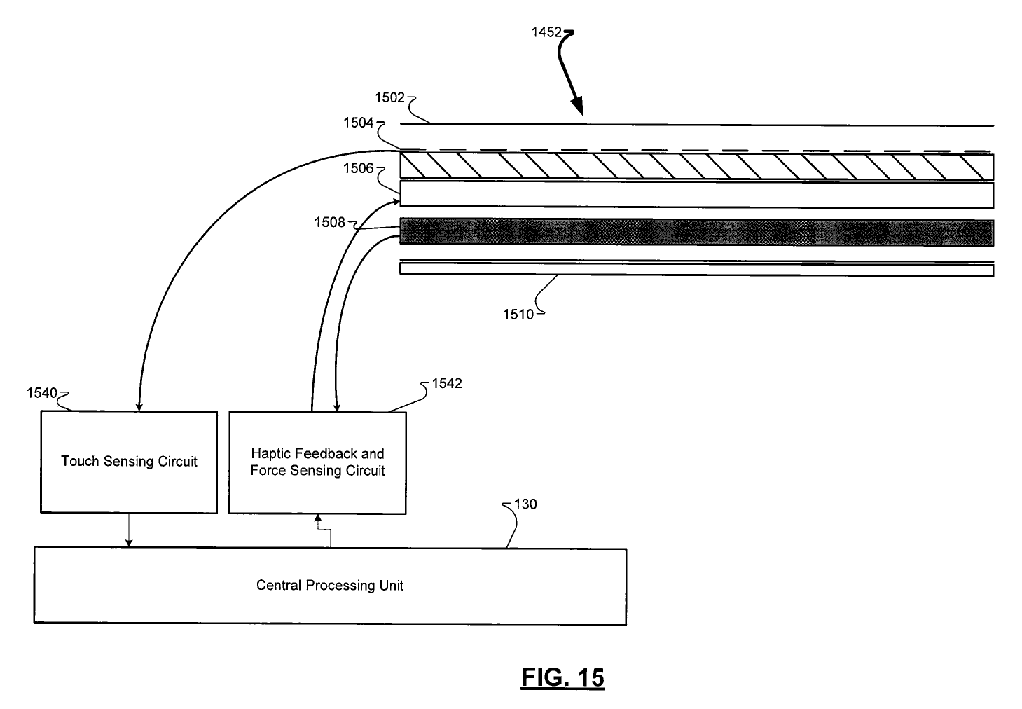

FIG. 15 illustrates an embodiment of a sensor 1452. It is appreciated that the sensors described herein can be used in place of input modules 120 described above. The sensor 1452 comprises a thin protective layer 1502, a contact sensitive layer 1504, an haptic layer 1506, a pressure sensitive layer 1508 and a hard surface encasing layer 1510.

The thin protective layer 1502 can be comprised of, for example, a PET film, acrylic, or plastic. The contact sensitive layer 1504 can be comprised of capacitive sensors, projected capacitive sensors, resistive sensors, digital resistive sensors, infrared sensors, or optic sensors. These sensors may be printed on a PCB. It is appreciated that the contact sensitive layer 1504, when contacted by the user, will generate a signal indicating that the sensors of the contact sensitive layer 1504 have been activated by the user. As can be appreciated, the signals generated by the activated sensors of the contact sensitive layer 1504 are further indicative of the locations of the contact. Thus, the central processing unit 130 can determine the points of contact between the user and the input device based on the locations of the activated sensors. As can be seen, the contact sensitive later 1504 is a component of the touch sensing circuit 1540.

The haptic layer 1506 is configured to provide physical feedback to the user. For example, the haptic layer 1506 may vibrate at a first frequency when the user places a finger over the sensor 1452, i.e. the user has activated the sensors of the contact sensitive layer 1504. The haptic layer 1506 may vibrate at a second frequency when the user applies a force greater than a predetermined threshold to the sensor 1452. For example, if the user has activated the pressure sensitive layer 1508. The haptic layer may be comprised of an electro-active polymer (EAP), e.g. a Artificial Muscle®, a piezoelectric material, an electrostatic vibrator, or a piezo-like material.

When the central processing unit 130 determines that a haptic response is required, the central processing unit 130 will apply a predetermined voltage to the haptic layer 1506, which would result in a vibration of the haptic layer. As is discussed below, the central processing unit 130 may be configured to disregard signals from the contact sensitive layer 1504 and the pressure sensitive layer 1508 when providing haptic feedback so that the vibrations caused by the haptic layer 1506 do not provide false sensor signals.

The pressure sensitive layer 1508 is configured to generate a voltage signal corresponding to an amount of pressure that is being applied to the sensor 1452. The voltage signal is communicated to the central processing unit 130, which compares the voltage signal with a predetermined threshold. If the voltage signal exceeds the predetermined threshold, then the central processing unit 130 determines that the sensor 1452 has been pressed. The pressure sensitive layer 1508 can be comprised of a piezoelectric material, a piezo-like material, a tensometric gauge, an artificial muscle or any other type of force or pressure sensing material. In some embodiments, the pressure sensitive layer 1508 may be comprised of capacitive sensors such that the central processing unit 130 determines an amount of pressure by the area of the activated capacitive sensors.

The hard surface encasing 1510 can be any hard surface that encases the components described above. For example, the hard surface encasing 1510 may be a printed circuit board.

As can be appreciated from FIG. 15, the contact sensitive layer 1504 and the force sensitive layer 1508 communicate signals to the central processing unit 130, while the central processing unit 130 communicates one or more signals to the haptic layer 1506 to provide haptic responses.

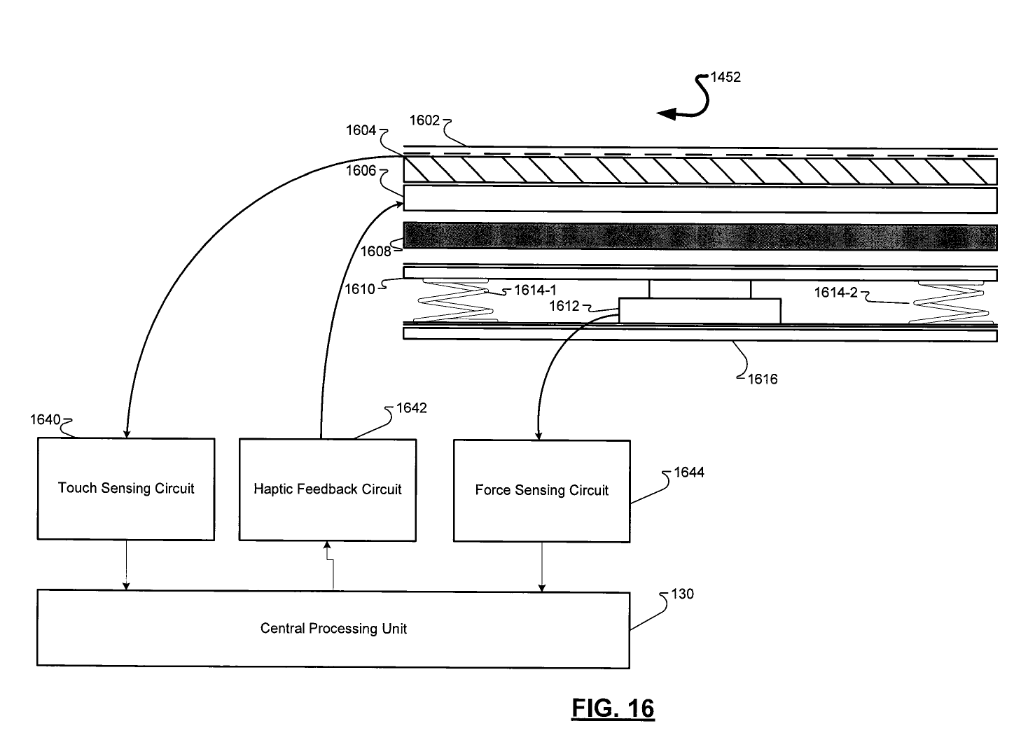

Referring now to FIG. 16, an alternative configuration of a sensor 1452 is shown. As can be seen, the sensor 1452 of FIG. 16 can be comprised of a protective film 1602, a contact sensitive layer 1604, a haptic response layer 1606, a pressure sensing layer 1608, and a hard surface encasing 1610. It is appreciated that these components are be similar to those described above. Further included in the sensor 1452 of FIG. 16 is a mechanical switch 1612 and a plurality of springs 1614-1 and 1614-2. It is appreciated that the mechanical switch is activated when the user asserts a downwardly force on the sensor 1452, thereby compressing springs 1614-1 and 1614-2 so that the hard surface encasing 1610 pushes the mechanical switch 1612. The mechanical switch indicates to the central processing unit 130 that the sensor 1452 has had at least a predetermined amount of force exerted upon it, thereby indicating a user input command.

In some embodiments the haptic feedback can be achieved using a spring and two conductive plates, wherein the spring has one plate at each end of the spring. The plates are electrostatically charged and are thereby attracted due to electrostatic forces. When the electrostatic signal is removed, the spring will push the plates apart to their original positions. It is appreciated that the central processing unit 130 can oscillate the electrostatic signal thereby causing the spring to oscillate. In some embodiments an amplifier may be interposed between the central processing unit 130 and the conductive plates of the haptic feedback layer to increase the charge and/or voltage on the plates. For example, the voltage may be increased to 1000V-2000V. It is appreciated that the spring providing haptic feedback may be the spring 1614-1 or 1614-2 of the mechanical switching mechanism 1612, or it can be an independent spring.

It is appreciated that each sensor 1452 may include more than one mechanical switch. Furthermore, as the mechanical switch senses an exerted force greater than a predetermined threshold, the pressure sensing layer 1608 may be omitted from this embodiment. Additionally, it is appreciated that the mechanical switch 1612 and the springs 1614-1 and 1614-2 may be interposed between the hard surface encasing 1610 and a second hard surface encasing 1616.

As can be seen from the FIG. 16, the contact sensitive layer 1504 and one or both of the force sensitive layer 1508 and the mechanical switch 1612 communicate signals to the central processing unit 130, while the central processing unit 130 communicates one or more signals to the haptic layer 1506 to provide haptic responses to the user.

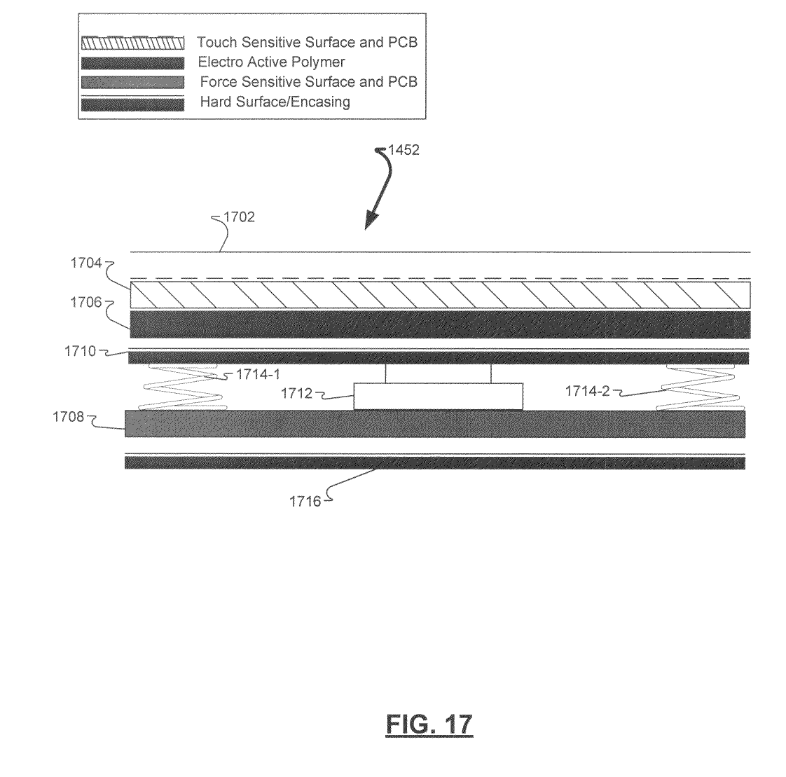

It is envisioned that various other configurations of the sensor 1452 exist. Referring to FIG. 17, an alternative configuration of a sensor 1452 is shown. As can be seen, the sensor 1452 includes a protective layer 1702, a contact sensitive layer 1704 and a hard surface encasing 1710 positioned above a mechanical switch 1712. The mechanical switch 1712 couples to a PCB such that when the mechanical switch 1712 is pressed, a signal is communicated to the central processing unit 130 via the PCB. The PCB sits atop the haptic layer 1708. A second hard surface enclosure 16 encloses the sensor 1452 sensor.

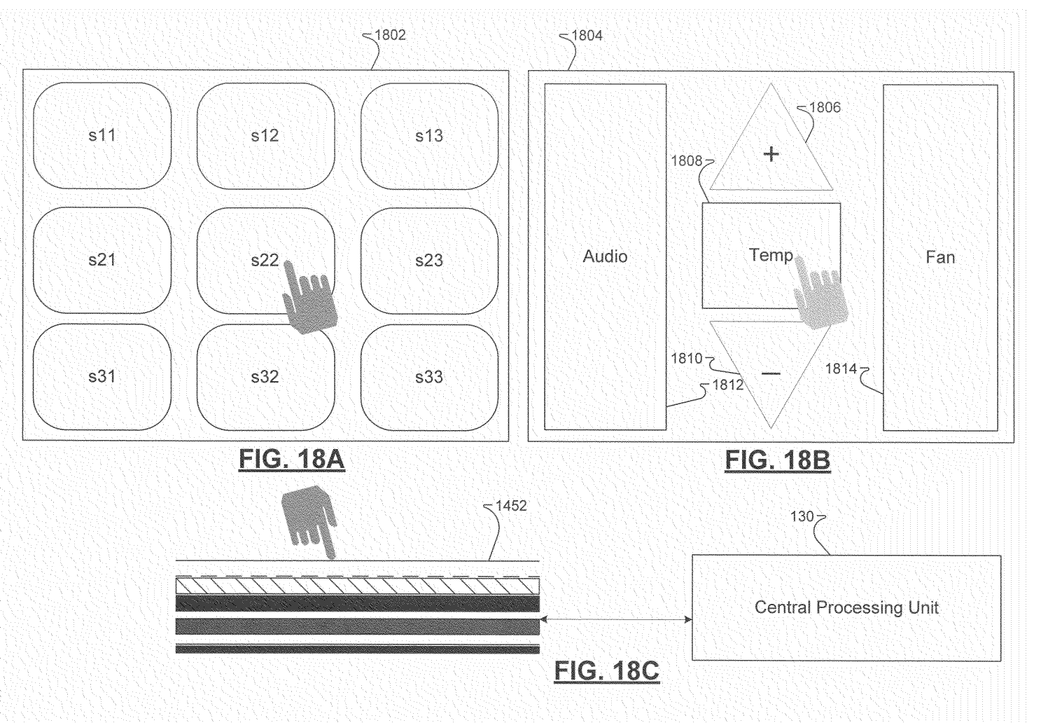

Given the various configurations, a touch screen or a touch sensitive input module can be comprised of a plurality of the sensors that are configured to receive user input and provide haptic feedback to the user. FIGS. 18A, 18B and 18C together illustrate a relationship between a particular sensor 1452 (FIG. 18C), an input module 1802 (FIG. 18A) having a plurality of sensors s11-s33 (e.g. a touchpad), and the display 1804 (FIG. 18C). In this example, there are nine sensors s11-s33. Each of these sensors are touch sensitive and pressure sensitive. The sensors can be arranged in the touchpad so that each sensor corresponds to a region of the touch pad. For example, when a user makes contact with a particular sensor, e.g. s22, the central processing unit 130 may send a signal to the display 1804 to display a virtual cursor at a particular location on the display 1804.

In another example, the sensor, e.g. s22, that is activated by the user causes the central processing unit 130 to execute a particular function. For example, a user may touch sensor s22. The contact with the sensor s22 commands the display 1804 to show the input options. In the example, by touching the sensor s22, the display 1804 will display an icon for the temperature settings. Displayed above the temperature icon is an increase icon 1806 and displayed below the temperature icon 1808 is a decrease icon 1810. To the left of the temperature icon 1808 is an audio icon 1812 and to the right of the temperature icon 1814 is a fan or HVAC icon. If the user wishes to toggle through a menu of options, the user can press the sensor s22. This would, for example, cause a new icon, e.g. the audio icon 1812, to be displayed in the center, such that the user can then increase or decrease the volume of the radio using icons 1806 and 1808.

Referring back to the example where the temperature icon is displayed in the center, the user can press the sensor S12 to increase the temperature. If the user merely touches the sensor s12, the display may prompt the user to press the button to increase the temperature. Furthermore, the central processing unit may generate a voltage signal that is communicated to the haptic layer of the sensor S12, thereby causing a vibration which indicates to the user that he is above a particular icon. When the user decides to increase the temperature, the user can forcibly press the sensor s12 such that the central processing unit 130 can determine that a command to increase the temperature is received. The central processing unit 130 would then send a signal to the CAN to increase the temperature.

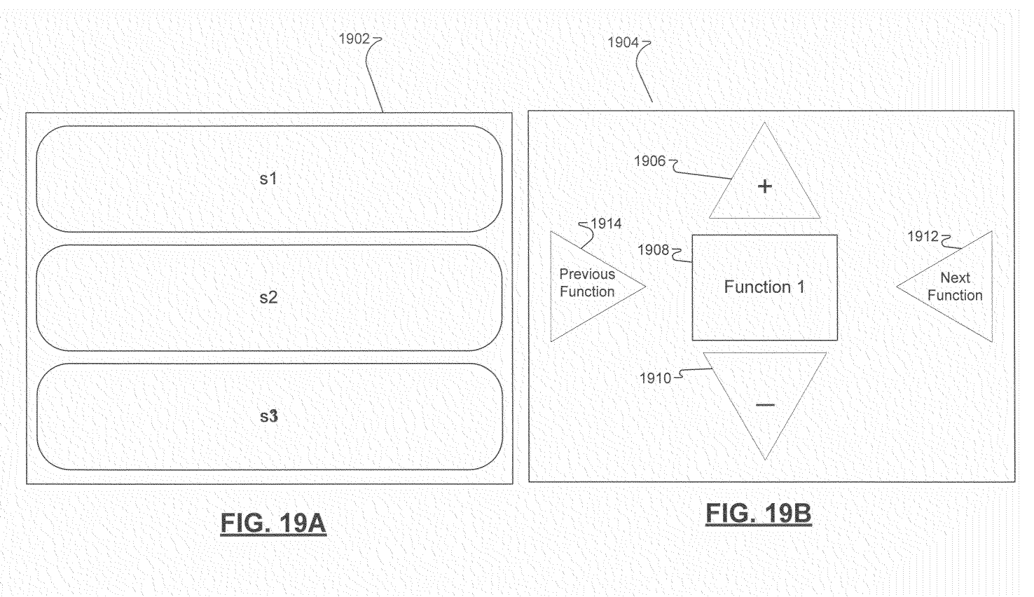

In some embodiments, the input device can be comprised of three sensors. FIGS. 19A and 19B together illustrate a relationship between an input module 1902 (FIG. 19A) comprised of three sensors s1-s3 and a display 1904 (FIG. 19B) corresponding thereto. It is appreciated that the input module may be a touchpad that controls a cursor on the screen or the input module 1902 may be a touch screen such that the display 1904 and the input module 1902 are a single unit. In the exemplary embodiment, the control function icon 1906 corresponds to sensor s2, while the increase icon corresponds to s1 and the decrease icon corresponds to sensor s3. If the user touches the sensor s2 the control functions will be displayed. If the user presses the sensor s2 the control functions will be toggled, e.g. temperature to audio. The user can change the settings of the control function by pressing either sensor s1 or s3.

It is further envisioned that in some embodiments, the middle sensor S2 can be used as a slider such that the current function is toggled when the contact sensitive layer of the sensor S2 senses the contact point between the user and the sensor continuously change from the left side of the sensor to the right side of the sensor or vice-versa. As can be seen on the display 1904, an arrow 1912 on the right side of the display 1904 pointing to the left indicates to the user that the user can toggle to the next function by sliding, for example, his or her finger to the right and across the middle of the input device 1902. Similarly, an arrow 1914 on the left side of the display 1904 pointing to the right indicates to the user that the user can toggle to the previous function by sliding, for example, his or her finger to the left and across the middle of the input device 1902. It is appreciated that the foregoing is an exemplary way to change the current executable function displayed to the user and that other means to do so are contemplated.

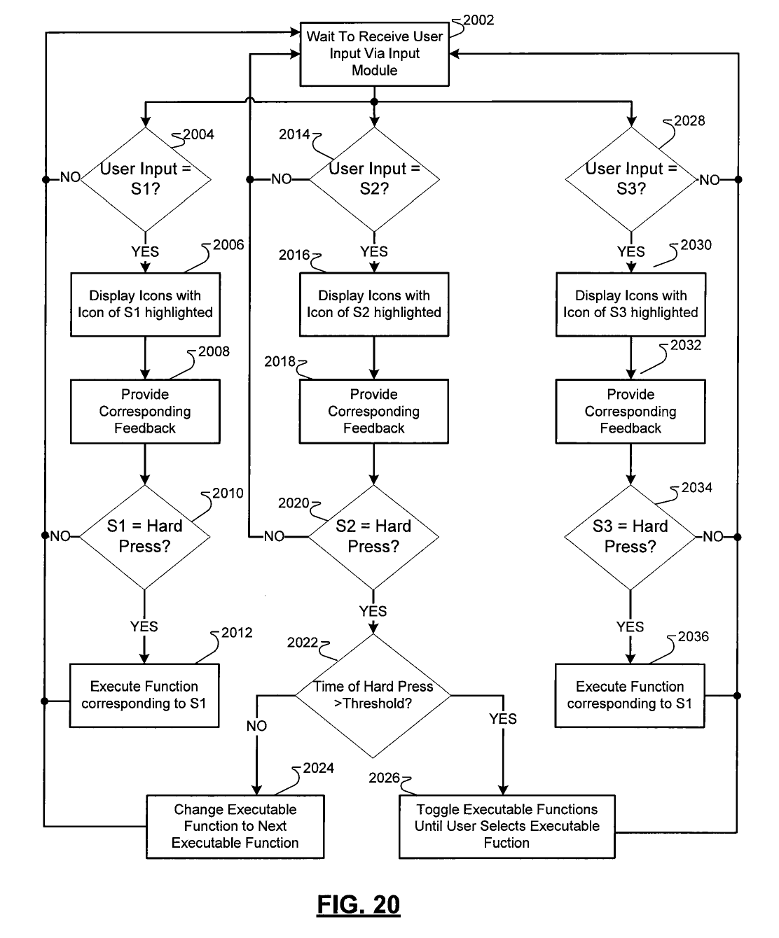

FIG. 20 illustrates an exemplary method that may be executed by the central processing unit 130 when receiving input from an input device having three dual function sensors. It is understood that the following method can be applied for an input module having any number of sensors.

As can be appreciated, that when the instrument panel of a vehicle is active, the central processing unit 130 will continuously await user input. Thus, once a user engages the input device, e.g. a touchpad or touch screen, the central processing unit 130 receives a signal that input was received, as shown at step 2000.

As mentioned above, in some embodiments, the touch surface is comprised of multiple dual function sensors. In this example, there are three sensors, wherein each sensor corresponds to a specific region of the input device. Thus, each sensor may have a unique signal or signals indicating to the central processing unit 130 which sensor was engaged by the user. As such, when a particular sensor is engaged, central processing unit 130 determines which sensor was activated by the user input, as shown at steps 2004, 2014 and 2028. A sensor is activated when at least one of the contact sensing circuit or the force sensing circuit generates a signal that is communicated to the central processing unit 130.

In the exemplary method, if the sensors S1 or S3 are engaged, the central processing unit 130 determines that the user wishes to execute a function which would adjust a setting of a particular system in the vehicle. For instance, the current adjustable setting may be the temperature setting. It is appreciated that the user may wish to increase or decrease the temperature. By touching S1 or S3 on the input device, the display will show the executable functions in the regions corresponding to S1 and S3 and the current adjustable setting at the region corresponding to S2. In some embodiments, the region corresponding to the sensor that was actually touched is highlighted apart from the other options in the display, as shown at steps 2006, 2016 and 2030 respectively. For instance, if the user touches the S1 switch, the up arrow may be displayed more brightly than the other options, or may be displayed in another color. It is appreciated that a timer may be used to display the executable functions for a predetermined time after the user disengages the sensors. For instance, the executable functions may be displayed according to the foregoing for 10 seconds after the user removes his or her finger from the input device. Additionally, the display 1904 may present instructions or suggestions to the user when the user activates the contact sensitive layer. For instance, when the user touches the sensor S1, the central processing unit 130 may instruct the display to present a message stating: “Press the up arrow to increase the temperature.” Alternatively, an audio instruction may be output through the vehicle speaker system.

Furthermore, the haptic feedback circuit of a particular sensor can generate haptic feedback to the user when the particular sensor is touched, as shown at steps 2008, 2018 and 2032. In these embodiments, the central processing unit 130 will generate a voltage signal which is applied to the haptic feedback circuit of the activated sensor. For instance, if the user touched sensor S2, the central processing unit 130 will apply a voltage signal to the haptic feedback circuit of the sensor s2. When the voltage signal is applied to the haptic circuit of the sensor s2, the haptic layer will vibrate at a frequency corresponding to the applied voltage signal. It is envisioned that in some embodiments the frequency of the voltage signal 130 varies depending on which sensor was activated by the use. This can indicate to the user which sensor was touched, which can allow the user to provide use the input device without looking at the display. It is further appreciated that in addition to haptic response, a user may be further provided with audio or visual feedback as well.

As can be appreciated, the haptic feedback, e.g. vibrations, may interfere with the sensor outputs of the pressure sensing layer or the contact sensing layer. Thus, the central processing unit 130 may be further configured to operate in a input mode and output mode, such that when the central processing unit 130 is providing haptic feedback it does not receive input from the sensing layers. Similarly, while receiving input from one or more of the sensing layers, the central processing unit 130 can be configured to refrain from sending a voltage signal to the haptic layers of the sensors.

The central processing unit 130 also determines whether the user forcibly pressed the touched sensor, as shown at steps 2010, 2020, and 2036. When a user forcibly presses one of the sensors s1, s2, or s3, the pressure sensing circuit of the sensor will generate a signal indicating that a pressure greater than a predetermined threshold was applied to the sensor. This may be achieved by a mechanical switch or a piezoelectric material, as discussed above.

When the user forcibly presses one of the sensors s1 or s3, the central processing unit 130 determines that the user wants to execute a function, as shown at steps 2012 and 2036. For instance, when the temperature setting is the current adjustable setting, the user pressing sensor s1 will cause the central processing unit 130 to send a signal to the HVAC to increase the temperature. Similarly, if the user presses sensor s3, the central processing unit 130 will send a signal to the HVAC to decrease the temperature.

When the user presses the sensor s2, the central processing unit 130 determines that the user wishes to change the current adjustable setting, as shown at step 2020. For example, the current adjustable setting may be set to temperature settings, but the user wishes to change the volume. The user may forcibly press sensor s2 to change the adjustable setting from the temperature settings to the volume settings. If the user presses the sensor for more than a predetermined period of time, then the central processing unit 130 determines that the central processing unit 130 toggles through the adjustable settings until the user releases the sensor s2. To toggle the adjustable settings, the central processing unit 130 sends a signal to the display, thereby causing the display to continuously change the icon presented to the user. If the user did not press the sensor s2 for more than a predetermined period of time, then the central processing unit 130 sends a signal to the display to present the next adjustable setting. In some embodiments, a similar determination is made for the other sensors, which are used to control the value of the adjustable setting. In these embodiments, when a user has pressed the sensor for more than a predetermined amount of time, the central processing unit 130 will adjust the values of the adjustable setting at an increased rate.

It is appreciated that a list of settings may have a particular order in which the adjustable settings are presented on the display. The adjustable setting presented on the display corresponds to the setting in the vehicle that can be adjusted via the input device. When a user selects an adjustable setting to be displayed, the state of the central processing unit 130 is updated so that when the user presses one of the sensors s1 and s3, the central processing unit 130 sends a signal to the proper vehicle system.

The foregoing method was provided for exemplary purposes. It is envisioned that the central processing unit 130 may be configured to execute variations of the method described above. Furthermore, while reference has been made to input devices being comprised of three or nine sensors, it is appreciated that the number of sensors in the input device may vary significantly and that the foregoing examples were provided for exemplary purposes.

The description of the invention is merely exemplary in nature and, thus, variations that do not depart from the gist of the invention are intended to be within the scope of the invention. Such variations are not to be regarded as a departure from the spirit and scope of the invention.

1. A control interface system in a vehicle comprising:
an input device that receives input of a user to control a plurality of systems of the vehicle;
a plurality of dual function sensors disposed along a surface of said input device, each of the dual function sensors having a first circuit that is sensitive to contact of the user with the surface of said input device and a second circuit sensitive to pressure exerted upon the surface of the input device exceeds a predetermined threshold, wherein the dual function sensor generates a first signal indicating contact of the user with the surface of the input device and generates a second signal indicating that pressure exerted upon the surface of the input device exceeds the predetermined threshold; and
a processing unit which receives the first and second signals and controls the plurality of systems within the vehicle based upon the received signals.

2. The control interface system of claim 1 wherein each of the plurality of dual function sensors further comprises a haptic feedback circuit that vibrates upon receiving a voltage signal from the processing unit, thereby causing the dual function sensor to vibrate, wherein the processing unit transmits the voltage signal to the haptic feedback circuit of a particular dual function sensor when the processing unit receives at least one of a first signal or a second signal from the particular dual function sensor.

3. The control interface system of claim 2 wherein the processing unit is configured to transmit a first voltage signal to the haptic feedback circuit of the particular dual function sensor upon receiving the first signal from the particular dual function sensor and to transmit a second voltage signal to the haptic feedback circuit of the particular dual function sensor upon receiving the second signal from the particular dual function sensor, whereby the haptic feedback circuit vibrates at a first frequency upon receiving the first voltage signal and vibrates at a second frequency upon receiving the second voltage signal.

4. The control interface system of claim 2 wherein the processing unit switch between an input mode and an output mode, wherein the input mode corresponds to receiving the first and second signals from the particular dual function sensor and the output mode corresponds to transmitting the voltage signal to the haptic feedback circuit of the particular dual function sensor.

5. The control interface system of claim 1 further comprising a display unit that presents an icon representing an executable function corresponding to one of the plurality of systems of the vehicle, wherein at least one of the plurality of dual function sensors maps to the icon.

6. The control interface system of claim 5 wherein the executable function is selected by the user when the user activates the second circuit of a predetermined dual function sensor on the surface of the input device.

7. The control interface system of claim 6 wherein the processing unit changes the executable function upon receiving a second signal from the predetermined dual function sensor.

8. The control interface system of claim 6 wherein processing unit changes the executable function upon receiving a first signal from the predetermined dual function sensor, wherein the first signal is indicative of the user sliding a finger across the predetermined dual function sensor.

9. The control interface system of claim 1 wherein the first signal generated by the first circuit is further indicative of a location of the contact between the user and the surface.

10. The control interface system of claim 1 wherein the first circuit is comprised of at least one of capacitive sensors and resistive sensors.

11. The control interface system of claim 1 wherein the second circuit is comprised of at least one of a piezoelectric material, a piezo-like material, and a mechanical switch.

12. The control interface system of claim 2 wherein the haptic feedback switch is comprised of at least one of a piezoelectric material, a piezo-like material, and an electro-active polymer.

13. The control interface system of claim 5 wherein the input device is a touch screen and wherein the input device is integrated into the display unit.

14. The control interface system of claim 5 wherein the input device is touch pad proximate to the user and wherein the touch pad is used to control a virtual curser presented on the display unit.

15. A user input device for controlling a plurality of adjustable settings of one or more systems in a vehicle comprising:
a plurality of dual function sensors disposed along a frontal surface of said device, each of the dual function sensors having a contact sensitive circuit, a pressure sensitive circuit, and a feedback circuit, wherein for each of the plurality of dual function sensors:
the contact sensitive circuit is configured to generate a first signal indicating contact between a user and the dual function sensor and a location thereof;
the pressure sensitive circuit is configured to generate a second signal indicating that an amount of pressure exceeding a predetermined threshold is being applied to the dual function sensor;
the feedback circuit is configured to generate feedback to the user indicating that at least one of the contact sensitive circuit and the pressure sensitive circuit of the dual function sensor has been activated;
a central processing unit configured to receive the first signals and the second signals from the plurality of dual function sensors and to determine a location and type of user input based on the received signals, wherein said user input controls a current adjustable setting of the plurality of adjustable settings.

16. The user input device of claim 15 wherein a display presents an icon representing the current adjustable setting to the user and the user enters user input to adjust the current adjustable setting by activating the pressure sensitive circuit of at least one of the plurality of dual function sensors.

17. The user input device of claim 16 wherein the current adjustable setting is selectable by the user, wherein the central processing unit changes the current adjustable setting to a next adjustable setting of the plurality of the adjustable settings upon receiving a second signal from a predetermined dual function sensor, wherein the central processing unit receives the second signal from the predetermined dual function sensor and changes the icon presented on the display to a next icon representing the next adjustable setting.

18. The user input device of claim 15 wherein the feedback generated by the feedback circuit is at least one of a haptic feedback, an audio feedback, or a visual feedback.

19. The user input device of claim 15 wherein the user input device is a touch pad located on a rear surface of a steering wheel of the vehicle.

20. The user input device of claim 15 wherein the user input device is a touch screen located in a console of the vehicle.

21. The user input device of claim 15 wherein the feedback circuit further comprises:
a spring;
a first conductive plate coupled to the a distal end of the spring; and
a second conductive plate coupled to the proximate end of the spring;
wherein the central processing unit electrostatically charges the first and second plate at a frequency corresponding to an desired frequency of haptic feedback.
